(19) United States
(12) Patent Application Publication
(10) Pub. No.: US 2013/0152677 A1
(43) Pub. Date: Jun. 20, 2013

(54) Method and apparatus for adjusting a density measuring device

(71) Applicant: ENDRESS + HAUSER PROCESS SOLUTIONS AG, Reinach (CH)

(72) Inventors: Stefan Brandlin, Weil am Rhein (DE); Jurgen Abraham, Horup (DE)

(73) Assignee: ENDRESS + HAUSER PROCESS SOLUTIONS AG, Reinach (CH)

(21) Appl. No.: 13/713,612

(22) Filed: Dec. 13, 2012

(30) Foreign Application Priority Data
Dec. 16, 2011 (DE) 10 2011 088 881.0

(51) Int. Cl. G01N 9/32; G01N 9/00

(52) U.S. Cl. CPC G01N 9/32; G01N 9/00
USPC 73/32 A; 73/32 R

(57) ABSTRACT

A method for adjusting a density measuring device, wherein the method includes at least the steps of: producing a reference medium of a predeterminable density; supplying the reference medium to an adjusted, reference, density measuring device; determining the density of the reference medium with the reference density measuring device; supplying the reference medium to the density measuring device to be adjusted; registering with the density measuring device to be adjusted a measured value representing the density; and associating the measured value with the density determined with the reference density measuring device. Further an apparatus for performing the method is noted.

The present invention relates to a method for adjusting a density measuring device and to a corresponding apparatus for performing the method. The terminology ‘density measuring device’ refers to any measuring device suitable for determining the density of a medium. By way of example, such can be a measuring transducer of vibration-type, which determines, besides density, the flow rate of a medium through a pipeline, in which the measuring transducer is located, or a so called oscillatory fork, which is suitable, besides for density measurement, also for fill level measurement in a container.

In order during operation to be able to associate a recorded measurement signal with a certain density value, a density measuring device is furnished with a characteristic curve, which shows the density dependence of the measurement signal. Due to deviations in the parameters determining the measurement signal, before start-up, an adjusting of the density measuring device is required, in the case of which the density measuring device is placed in an adjusting apparatus containing a reference medium of known density, at least one measurement signal is registered at the known density and the proper association for the particular measuring device is ascertained.

As a result of aging processes and wear of the components of the density measuring device, a shifting of the characteristic curve can arise, so that, in the case of a density measuring device, which is in use, after a certain amount of time, a renewed adjusting can be required. As a function of the process medium, such a readjusting can be difficult, for example, in case in which the medium strongly foams. Often, bypasses with large superstructures are present, which makes the adjusting complicated and costly.

An object of the invention is to provide method and apparatus for performing the method, whereby an adjusting of a density measuring device is performable in simple manner at the location of use.

The object is achieved by a method for adjusting a density measuring device, wherein the method comprises steps as follows:
producing a reference medium of a predeterminable density;
supplying the reference medium to an adjusted, reference, density measuring device and determining the density of the reference medium with the reference density measuring device;
supplying the reference medium to the density measuring device to be adjusted;
registering with the density measuring device to be adjusted a measured value representing the density; and
associating the measured value with the density determined with the reference density measuring device.

In an advantageous further development of the method, the reference medium is heated to a predeterminable temperature and the measured value is registered at the predetermined temperature.

In an embodiment, the reference medium is produced in a transportable container, fed for adjusting to the density measuring device to be adjusted and after the adjusting fed back into the container. The terminology ‘transportable container’ means a container, which is embodied in such a manner that it can be transported by a person.

The object is furthermore achieved by an apparatus for adjusting a density measuring device according to independent claim 4. The apparatus of the invention includes a container for accommodating a reference medium of predeterminable density, a supply line, which supplies the reference medium to the density measuring device to be adjusted, and an adjusted, reference, density measuring device, which is inserted into the supply line and is embodied to determine and to indicate the density of the reference medium. The apparatus is suitable for performing the method of the invention.

A embodiment of the apparatus provides that the container has a heating element, by means of which the reference medium is heatable to a predeterminable temperature.

In an embodiment, the apparatus includes a return line, which leads the reference medium from the density measuring device to be adjusted back into the container.

In a related embodiment of the apparatus, at least the return line includes at least one valve, which is embodied to prevent the occurrence of air bubbles in the reference medium.

In an advantageous embodiment, the apparatus includes a rollable holder, on which at least the container, the supply line and the reference density measuring device are mounted.

In an embodiment the apparatus includes at least one pump with controllable power for supplying the reference medium.

In an embodiment of the apparatus, the reference density measuring device is a density sensitive, Coriolis, mass flow transducer.

The apparatus of the invention is compact, handy and transportable and, thus, suitable for mobile density adjustment. For example, a service technician can transport the mobile density adjustment apparatus easily from site to site. Preferably, the apparatus is, consequently, mounted on a rollable holder, which further facilitates the transport. An additional advantage of the apparatus is that density measuring devices of any type can be adjusted by means of the apparatus. The adjusting is not limited to a measuring device structurally- or functionally equal to the reference density measuring device. For example, Coriolis, mass flow transducers and vibronic density measuring devices are equally adjustable with the apparatus.

Because of the flexibly manufacturable reference medium, the density measuring device is adjustable with a selectable density, for example, a density, which corresponds to the expected density of the process medium. Since the reference medium is provided by the adjusting apparatus, a diversion of the process medium is not required for the adjusting.

The apparatus of the invention and the method of the invention will now be explained in greater detail based on the appended drawing, the figures of which show as follows:

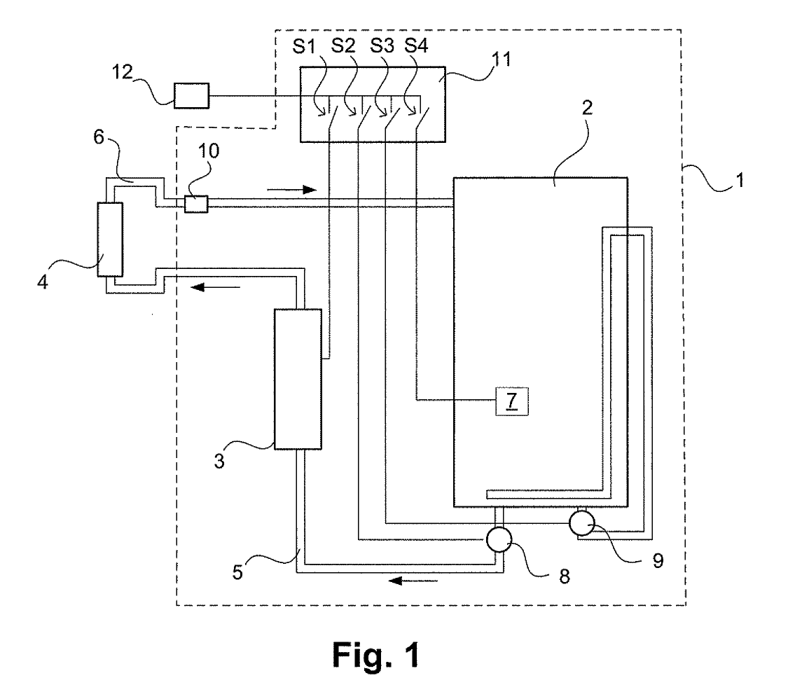

FIG. 1 schematic structural view of an apparatus for adjusting a density measuring device; and

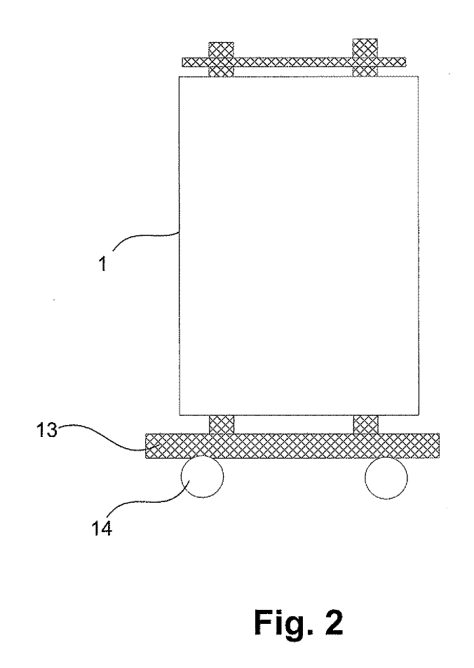

FIG. 2 a schematic total view of the apparatus.

FIG. 1 shows a schematic structural view of an adjusting apparatus 1 of the invention. The apparatus is suited equally for first adjustment, as well as also for readjustment, of density measuring devices 4. By mixing at least two media in the container 2, a reference medium of predeterminable density can be produced. One of the media is a liquid, for example, water. The second medium is, for example, a salt or some other medium, which is soluble in the first medium, so that, as reference medium, a homogeneous reference solution can be produced, which has a density, which is adjustable by the mixing ratio of the first and second media. The media are introducible manually into the container 2. Alternatively, however, also an automatic production of the reference medium via a dosing system is an option. A circulation pump 9 mixes the two media, so that the homogeneity of the reference medium required for an exact adjusting is assured.

The homogeneous reference medium is suppliable via a supply line 5 to the density measuring device to be adjusted 4. The density measuring device to be adjusted 4 can be of any form, wherein it need not be a measuring device dedicated to measuring density alone. Thus, the density measuring device 4 can be embodied for determining a plurality of process variables. For example, it can be a Coriolis, mass flow transducer or a so called oscillatory fork, which, besides density, can also determine viscosity or the fill level of a medium and frequently is used as a limit level switch.

Furthermore, the apparatus 1 has a return line 6, via which the reference medium can flow back from the density measuring device to be adjusted 4 into the container 2. Supply line 5 and return line 6 are, in each case, embodied in such a manner that the density measuring device to be adjusted 4 is connectable directly, or via intermediate pieces, with the supply line 5 and with the return line 6. It is, however, likewise an option to connect the supply line 5 and the return line 6 with a containment, in which the density measuring device to be adjusted 4 is placed. This is especially required for the above mentioned oscillatory fork, since such has no tubular piece flowed through by medium. A transport pump 8 transports the reference medium through the lines 5, 6. Supply line 5 and return line 6 are, for example, hoses or flexible tubing.

Fixedly placed in supply line 5 is a reference density measuring device 3. Reference density measuring device 3 is adjusted, preferably calibrated, so that the density of the reference medium is determinable by means of the reference measuring device 3 and, thus, is known exactly. Preferably, reference density measuring device 3 is embodied as a Coriolis, mass flow transducer, since such a measuring device 3 is integrateable, in simple manner, into the supply line 5, has a high accuracy in the case of density measurement and, supplementally, is suitable for determining the flow of the reference medium. The power of the transport pump 8 is controllable to an optimum as a function of the measured flow. Apparatus 1 can, however, also be equipped with another reference density measuring device.

Placed in the return line 6 is a valve 10, for example, a membrane valve. Via valve 10, a back-pressure is producible in the density measuring device to be adjusted 4 and in the reference density measuring device 3. In this way, it is assured that no air bubbles are located in the reference medium, which could degrade the density measurement.

Container 2 has a heating element 7, which serves for heating the reference medium to a predeterminable temperature. For example, the heating element 7 is embodied as an immersion heater. The settable temperature range lies, in such case, advantageously between room temperature and about 60° C. The heating element 7 makes the density adjustment performable at a not only known, but, instead, also predeterminable, temperature.

Located in a distribution box 11 are switches S2-S4 for operating the pumps 8, 9 and for turning the heating element 7 on. The switches can be control switches, so that the RPM of the pumps 8, 9, or the temperature of the heating element 7 is then adjustable. Furthermore, a switch S1 for energy supply of the reference density measuring device 3 is provided.

For performing the method, the reference medium is produced in the container 2 by mixing the at least two fundamental media with one another. The ratio of the fundamental media is selectable according to the desired density of the reference medium 2. The density measuring device to be adjusted 4 is connected to the supply line 5 and the return line 6. By means of the heating element 7, the reference medium is optionally heated to a certain temperature. The transport pump 8 is turned on and the reference medium transported through the two density measuring devices 3, 4. The measured value displayed by the density measuring device to be adjusted 4 is associated with the density value output by the reference density measuring device 3 and the value pair stored in the electronics unit of the density measuring device to be adjusted 4. Optionally, another measurement at another density of the reference medium or at another temperature can be performed.

FIG. 2 represents a schematic, total view of the adjusting apparatus 1. The components of the adjusting apparatus 1 are, in such case, not separately shown. In order to be able to transport the adjusting apparatus 1 easily, the individual components of the apparatus 1 are mounted on a holder 13, which is embodied, for example, as a metal frame. Mounted on the holder 13 are two rollers 14. The holder 13 can, however, also have only one roller, or more than two rollers, especially 4 rollers. Due to the rollers 14, the apparatus 1 is comfortably transportable to the location of use. The mobile adjusting apparatus 1 is so compact that it is movable without problem by one person.

### LIST OF REFERENCE CHARACTERS

1 adjusting apparatus
2 container
3 reference density measuring device
4 density measuring device to be adjusted
5 supply line
6 return line
7 heating element
8 transport pump
9 circulation pump
10 valve
11 distribution box
12 voltage source
13 holder
14 roller
S1 switch
S2 switch
S3 switch
S4 switch

1-10. (canceled)

11. A method for adjusting a density measuring device, wherein the method comprises the steps of:
producing a reference medium of a predeterminable density;
supplying the reference medium to an adjusted, reference, density measuring device and determining the density of the reference medium with the reference density measuring device;
supplying the reference medium to the density measuring device to be adjusted;
registering with the density measuring device to be adjusted a measured value representing the density; and
associating the measured value with the density determined with the reference density measuring device.

12. The method as claimed in claim 11, further:
heating the reference medium to a predeterminable temperature and the measured value is registered at the predetermined temperature.

13. The method as claimed in claim 11, wherein:
the reference medium is produced in a transportable container, fed for adjusting to the density measuring device to be adjusted and after the adjusting, fed back into the container.

14. An apparatus for adjusting a density measuring device according to a method including: producing a reference medium of a predeterminable density; supplying the reference medium to an adjusted, reference, density measuring device and determining the density of the reference medium with the reference density measuring device; supplying the reference medium to the density measuring device to be adjusted; registering with the density measuring device to be adjusted a measured value representing the density; and associating the measured value with the density determined with the reference density measuring device, wherein the apparatus comprises:
a container for accommodating a reference medium of predeterminable density;
a supply line, which supplies the reference medium to the density measuring device to be adjusted; and
an adjusted, reference, density measuring device, which is inserted into a supply line and is embodied to determine and to indicate the density of the reference medium.

15. The apparatus as claimed in claim 14, further comprising:
a container having a heating element, by means of which the reference medium is heatable to a predeterminable temperature.

16. The apparatus as claimed in claim 15, further comprising:
a return line, which leads the reference medium from said density measuring device to be adjusted back into said container.

17. The apparatus as claimed in claim 16, wherein:
at least the return line includes at least one valve, which is embodied to prevent the occurrence of air bubbles in the reference medium.

18. The apparatus as claimed in claim 15, further comprising:
a rollable holder, on which at least said container, said supply line and said reference density measuring device are mounted.

19. The apparatus as claimed in claim 14, further comprising:
at least one pump with controllable power for supplying the reference medium.

20. The apparatus as claimed in claim 14, wherein:
said reference density measuring device is a density sensitive, Coriolis, mass flow transducer.
